(19) United States
(12) Patent Application Publication
(10) Pub. No.: US 2013/0158742 A1
(43) Pub. Date: Jun. 20, 2013

(54) SYSTEM AND METHOD FOR COMMUNICATING IN A TRANSPORTATION NETWORK

(71) Applicants: Jared Cooper, Melbourne, FL (US); Ajith Kuttannair Kumar, Erie, PA (US); Joseph Noffsinger, Grain Valley, MO (US); Mason Samuels, Melbourne, FL (US); Joel Kickbusch, Melbourne, FL (US); Mahir Telatar, Melbourne, FL (US)

(72) Inventors: Jared Cooper, Melbourne, FL (US); Ajith Kuttannair Kumar, Erie, PA (US); Joseph Noffsinger, Grain Valley, MO (US); Mason Samuels, Melbourne, FL (US); Joel Kickbusch, Melbourne, FL (US); Mahir Telatar, Melbourne, FL (US)

(21) Appl. No.: 13/326,381

(22) Filed: Dec. 15, 2011

(51) Int. Cl. G08G 9/00

(52) U.S. Cl. 701/2; 701/117

(57) ABSTRACT

A system includes a communication unit configured to communicate with a scheduling system that determines schedules for plural vehicles to travel in a transportation network and with a control system that forms a trip plan for a first vehicle of the plural vehicles comprising operational settings for controlling movement of the first vehicle during a trip in the transportation network. The communication unit is configured to convey information between the scheduling system and the control system such that the scheduling system coordinates the schedules of the vehicles to maintain a throughput parameter of the transportation network and the control system forms the trip plan that reduces at least one of an amount of fuel consumed or an amount of emissions generated by the first vehicle during the trip according to the schedule associated with the first vehicle.

### BACKGROUND

Transportation networks may include a variety of systems that communication information during travel of vehicles in the networks. The networks may be formed from interconnected routes, such as roads, tracks, waterways, and the like. The vehicles may include automobiles, rail vehicles, other off-highway vehicles (OHV), and the like.

Known vehicles such as locomotives communicate with off-board systems to coordinate and/or determine the travel of the vehicles in the transportation network. For example, trains may communicate with off-board systems to receive schedules and the like from the systems. The trains can report information back to the systems, such as current locations, warnings of a malfunction, and the like.

Currently, some known vehicles and systems are limited to which other systems and vehicles that each may communicate with. For example, different systems that are provided by different manufacturers may use different communication formats that cannot be read or understood by each other. Moreover, a variety of different vehicles that also use different communication formats, protocols, and the like may travel through the transportation network. If the vehicles and off-board systems use incompatible communication formats, then the vehicles and systems may be unable to communicate.

Additionally, the amount of bandwidth that is available for communication between the systems and/or the computational resources of the systems may be limited. When the systems are attempting to coordinate travel of a relatively large number of vehicles (e.g., hundreds of vehicles) in the same area using wireless communication between systems on the vehicles and systems disposed off-board the vehicles, the systems may be limited in how much data and/or how frequently data can be communicated between the systems. Moreover, frequent communication of data between the systems can increase the potential for some of the data to be dropped (e.g., not received by an intended recipient system).

A need exists for a system and method that allows different vehicles and/or systems that to communicate with each other in order to coordinate travel of the vehicles in a transportation network.

### BRIEF DESCRIPTION

In one embodiment, a system is provided that includes a communication unit configured to communicate with a scheduling system that determines schedules for plural vehicles to travel in a transportation network and with a control system that forms a trip plan for controlling movement of one or more of the vehicles during a trip in the transportation network. The communication unit is configured to convey information between the scheduling system and the control system such that the scheduling system coordinates the schedules of the vehicles to maintain a throughput parameter of the transportation network and the control system forms the trip plan that reduces at least one of an amount of fuel consumed or an amount of emissions generated by the one or more of the vehicles during the trip according to the schedule associated with the one or more vehicles.

In another embodiment, a method is provided that includes receiving information from at least one of a scheduling system and a control system. The scheduling system determines schedules for plural vehicles traveling along interconnected routes of a transportation network. The control system forms a trip plan for controlling at least one of tractive efforts or braking efforts of one or more of the vehicles during a trip of the one or more of the vehicles in the transportation network. The method also includes conveying the information to the other of the scheduling system or the control system such that the scheduling system coordinates the schedules of the vehicles to maintain a throughput parameter of the transportation network or the control system forms the trip plan that is used by the one or more of the vehicles to reduce an amount of fuel consumed during the trip of the one or more of the vehicles according to at least one of the schedules associated with the one or more vehicles.

In another embodiment, another system (e.g., a system for communicating with vehicles) includes a scheduling module, a communication module, and a monitoring module. The scheduling module is configured to determine scheduling information for plural vehicles that directs movement of the vehicles in a transportation network. The scheduling information includes plural locations and associated arrival times for each of the vehicles to travel to the locations. The communication module is configured to communicate the scheduling information to the vehicles. The monitoring module is configured to determine a bandwidth limitation of a communication link over which the scheduling information is communicated with one or more of the vehicles. The scheduling module is configured to direct the communication module to reduce an amount of the scheduling information that is communicated to the vehicles when the bandwidth limitation falls below a designated threshold by decreasing a number of the locations and the associated arrival times that are communicated to the vehicles.

In another embodiment, another method (e.g., a method for communicating with vehicles) includes determining scheduling information for plural vehicles that directs movement of the vehicles in a transportation network. The scheduling information includes plural locations and associated arrival times for each of the vehicles to travel to the locations. The method also includes communicating the scheduling information to the vehicles and monitoring a bandwidth limitation of a communication link over which the scheduling information is communicated with one or more of the vehicles. An amount of the scheduling information that is communicated to the vehicles is reduced when the bandwidth limitation falls below a designated threshold by decreasing a number of the locations and the associated arrival times that are communicated to the vehicles.

### BRIEF DESCRIPTION OF THE DRAWINGS

FIG. 1 is a schematic diagram of one embodiment of a transportation network.

FIG. 2 is a schematic diagram of one embodiment of a communication unit shown in FIG. 1.

FIG. 3 is a flowchart of a method for communicating information between systems in accordance with one embodiment.

### DETAILED DESCRIPTION

In accordance with one or more embodiments described herein, a system and method are provided that enable communication between a scheduling system and an energy management system in order to coordinate travel of vehicles in a transportation network. The travel of the vehicles may be coordinated such that a throughput parameter of the transportation network (or a portion thereof) is increased or is maintained above a designated threshold. The throughput parameter may represent the flow of vehicles through the transportation network such that a low throughput parameter can indicate traffic congestion or deadlock in the transportation network while a larger throughput parameter can indicate movement of the vehicles in the transportation network according to, or close to, associated schedules of the vehicles. The scheduling system establishes schedules for the vehicles and the energy management system uses the schedule for a vehicle to define a trip plan for the vehicle. The trip plan may direct movement of the vehicle such that the vehicle travels according to the schedule associated with the vehicle (or within a predetermined range of the scheduled times of the schedule) while reducing an amount of fuel consumed by the vehicle and/or an amount of emissions generated by the vehicle. In one embodiment, the trip plan dictates specific vehicle control for a single vehicle (which may include several vehicles coupled together such as in a consist or train). The vehicle control that may be dictated by the trip plan can include operational settings for controlling movement of the vehicle expressed as a function of time and/or distance along a trip or mission. For example, the trip plan may include different speeds, tractive efforts (e.g., throttle settings or generated horsepower), braking efforts (e.g., brake settings), and the like, for the vehicle to travel according to at different locations along a route and/or at different times during travel along the route. Multiple different trip plans may be created for and used by separate vehicles (e.g., not mechanically coupled) that are concurrently traveling in a transportation network.

The system and method may permit communication between different systems, such as the scheduling system, the energy management system, and/or one or more other systems, that coordinate, limit, or otherwise have an impact on movement of the vehicles in the transportation network. Formats of the communication between the different systems may be converted or otherwise changed to ensure that the different systems are able to communicate with each other, even if the systems use different communication formats or protocols to transmit and/or receive information. The timing at which information transmitted from two or more systems to a receiving system may be controlled so that the receiving system receives the information in an order that can be used by the receiving system. In one embodiment, a communication unit is provided that permits communication of information as described above between scheduling systems, energy management systems, or other systems that impact travel of vehicles in the transportation network, where the communication unit permits communication between different systems that are controlled, installed, and/or provided by different parties (e.g., manufacturing or installation entities or companies). Such a communication unit can prevent having to individually configure the systems to be able to communicate with each other and/or can allow for systems that previously were unable to communicate to now communicate with each other.

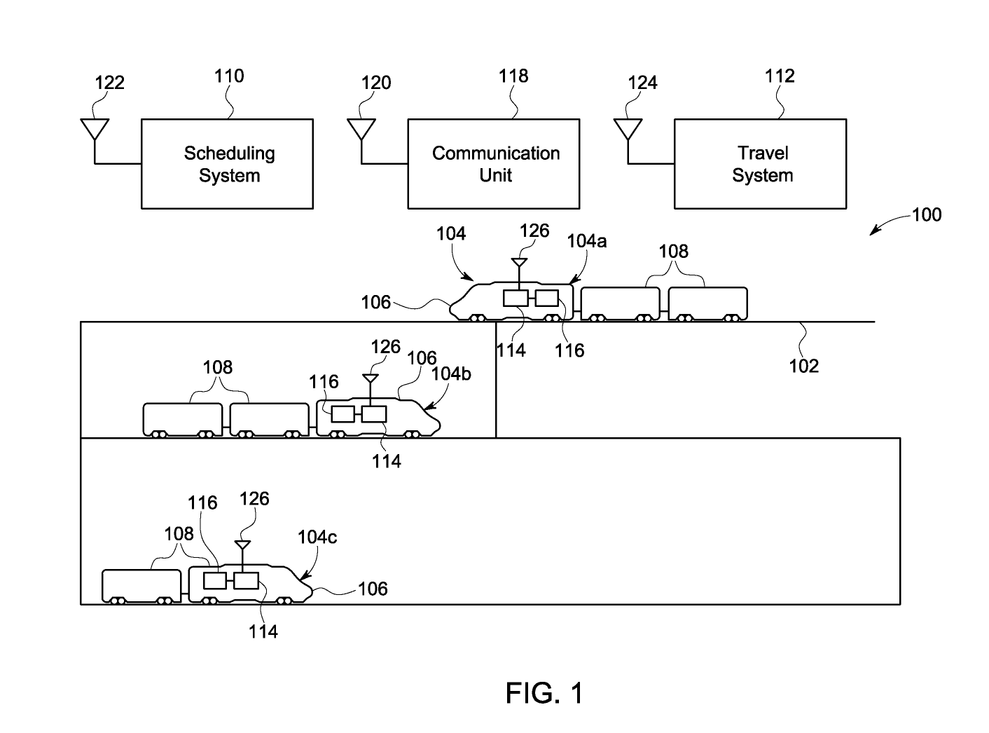

FIG. 1 is a schematic diagram of one embodiment of a transportation network 100. The transportation network 100 includes a plurality of interconnected routes 102, such as railroad tracks, roads, or other paths across which vehicles travel. The transportation network 100 may extend over a relatively large area, such as hundreds of square miles or kilometers of land area. The routes 102 may represent paths taken by vehicles 104 to travel in the transportation network 100. By “travel in” the transportation network 100, it is meant that one or more of the vehicles 104 move from one location to another with at least part of the movement of the one or more vehicles 104 being in the transportation network 100. By way of example, the routes 102 may represent railroad tracks, roads, marine routes or paths, airline routes or paths, or the like. The number of routes 102 shown in FIG. 1 is meant to be illustrative and not limiting on all embodiments of the described subject matter. Moreover, while the discussion herein may focus on a transportation network formed from railroad tracks, not all embodiments are so limited. One or more embodiments may relate to transportation networks in which vehicles other than rail vehicles travel.

Several vehicles 104 may concurrently travel along the routes 102 in the transportation network 100. In the illustrated embodiment, the vehicles 104 are shown and described herein as rail vehicles or rail vehicle consists. However, one or more other embodiments may relate to vehicles other than rail vehicles or rail vehicle consists. The vehicles 104 are individually referred to by the reference numbers 104a, 104b, and 104c. While three vehicles 104 are shown in FIG. 1, alternatively, a different number of vehicles 104 may be concurrently traveling in the transportation network 100.

A vehicle 104 may include a group of powered units 106 (e.g., locomotives or other vehicles capable of self-propulsion) and/or non-powered units 108 (e.g., cargo cars, passenger cars, or other vehicles incapable of self-propulsion) that are mechanically coupled or linked together to travel along the routes 102. The routes 102 are interconnected to permit the vehicles 104 to travel over various combinations of the routes 102 to move from a starting location to a destination location.

In one embodiment, the vehicles 104 travel along the routes 102 according to a movement plan of the transportation network 100. The movement plan can include schedules for different vehicles 104 with the schedules being coordinated, or based on one or more other schedules, to coordinate movement of the vehicles 104 in the transportation network 100. The schedules can include destination locations and associated arrival times. The vehicles 104 associated with the schedules travel along the routes 102 to arrive at the scheduled destination location at the scheduled arrival time. The schedules may be coordinated such that two or more vehicles 104 do not collide or come within a designated buffer distance from each other. For example, in a transportation network 100 having one or more routes 102 formed from a single railroad track, the schedules of two or more vehicles 104 may be coordinated such that the vehicles 104 are not scheduled to travel in opposite directions on the same section of the single railroad track at the same time without having a siding section or other section of track for at least one of the vehicles 104 to move onto.

The movement plan and/or the schedules of the vehicles 104 may be determined by a scheduling system 110. As shown in FIG. 1, the scheduling system 110 can be disposed off-board (e.g., outside) of the vehicles 104. For example, the scheduling system 110 may be disposed at a central dispatch office for a railroad company. Alternatively, the scheduling system 110 may be disposed on-board one or more of the vehicles 104. The scheduling system 110 can generate the schedules based on current locations of the vehicles 104, expected (e.g., scheduled) locations of the vehicles 104 during subsequent time periods, priorities between the different vehicles 104 (e.g., a first vehicle 104 may have a greater priority relative to a second vehicle 104 such that the first vehicle 104 is scheduled to travel over a common segment of a route 102 before the second vehicle 104 in order for both the first and second vehicles 104 to reach scheduled destinations), times that the vehicles 104 are needed at a destination location, potential routes 102 for the vehicles 104 to travel across to the associated destination locations, and the like.

In one embodiment, the scheduling system 110 creates schedule information that is communicated to direct movement of the vehicles 104 according to schedules associated with the vehicles 104. The schedule information can include destination locations for the vehicles 104 to travel toward, scheduled arrival times at which the vehicles 104 are to arrive at the destination locations, routes 102 over which the vehicles 104 are to travel to reach the destination locations, events between two or more of the vehicles 104 (e.g., meet events where two vehicles 104 traveling in opposite directions meet at a common section of a route 102 and one of the vehicles 104 pulls off of the route 102 to permit the other vehicle 104 to pass, pass events where a first vehicle 104 pulls off of the route 102 to permit a second vehicle 104 traveling in the same direction on the same route 102 to pass, and the like), current locations of the vehicles 104 (e.g., as determined by the scheduling system 110 and/or the vehicles 104, such as by Global Positioning System receivers on the vehicles 104), and the like. The schedule information can be used by the vehicles 104 to travel through the transportation network 100 toward the destination locations of the schedule information.

In addition to the scheduling system 110, one or more other travel systems 112 may direct travel of the vehicles 104 in the transportation network 100. The travel system 112 shown in FIG. 1 may represent a single or multiple systems that generate information used to direct movement of one or more vehicles 104 in the transportation network 100. For example, the travel system 112 may include a safety system that restricts movement of the vehicles 104 in order to avoid accidents and/or damage to the vehicles 104, the routes 102, and/or pedestrians. Such a safety system can generate safety information that is used by the scheduling system 110 and/or the vehicles 104 to limit where the vehicles 104 may travel, the speed of the vehicles 104, and/or provide one or more other restrictions on the vehicles 104. The safety information can include separation distances between vehicles 104 (e.g., buffer distances that one or more vehicles 104 are required to maintain from other vehicles 104), speed limits (e.g., limits on how fast the vehicles 104 can travel in different areas and/or routes 102), travel restrictions (e.g., slow orders that limit speed of the vehicles 104 in areas of the routes 102 that are under repair and/or people are working on the routes 102 and/or sections of the routes 102 that are under repair and cannot be traveled by the vehicles 104), and the like. In one embodiment, the travel system 112 includes a positive train control (PTC) safety system that monitors and/or controls movements of the vehicles 104 to ensure safe travel of the vehicles 104.

The safety information can be used by the vehicles 104 to prevent the vehicles 104 from traveling in an unsafe manner that can cause damage and/or injury to other vehicles 104 or persons. In one embodiment, the safety information can be used by the scheduling system 110 to generate the schedules for the vehicles 104. For example, the scheduling system 110 can consider restrictions on how fast a vehicle 104 can travel and/or where the vehicle 104 can travel and, based on these restrictions, generate an appropriate schedule for the vehicle 104.

Alternatively, the travel system 112 can include one or more other systems that generate information used by the vehicles 104 to determine where and/or when to travel in the transportation network 100. By way of example, the travel system 112 can include or represent a system that assigns priorities to the vehicles 104 so that some vehicles 104 have higher priorities to travel in the transportation network 100 relative to other vehicles 104. The travel system 112 can include or represent a system that arranges for other vehicles to enter onto the routes 102 for repair or to provide other services. Alternatively, the travel system 112 can include or represent another system that generates information used to impact (e.g., control or change) travel of the vehicles 104 traveling in the transportation network 100.

The vehicles 104 include control systems 114 disposed on-board the vehicles 104. The control systems 114 receive the information generated by the scheduling system 110 and/or the travel system 112 and generate control signals based on the information that is received. The control signals can be used to control propulsion of the vehicles 104 through the transportation network 100. For example, the control system 114 may examine the schedule information, such as by determining the scheduled destination location and scheduled arrival time, and generates control signals based on the schedule information. As another example, the control system 114 may receive safety information from the travel system 112, such as speed limits, sections of the routes 102 that cannot be traversed by the vehicle 104, and the like, and generate control signals based on the safety information.

The control signals may be used to automatically control movement of the vehicle 104 such that the vehicle 104 self-propels along the routes 102 to the destination location. For example, the control system 114 may be operatively coupled with a propulsion subsystem 116 of the vehicle 104. The propulsion subsystem 116 may include motors (such as traction motors), engines, brakes (such as air brakes and/or regenerative brakes), and the like, that generate tractive energy to propel the vehicle 104 and/or that generate braking energy to slow movement of the vehicle 104 (e.g., by applying air brakes or regenerative energy brakes). The control system 114 may generate control signals that automatically control the propulsion subsystem 116, such as by automatically changing throttle settings and/or brake settings of the propulsion subsystem 116. In another embodiment, the control signals may be used to prompt an operator of the vehicle 104 to manually control the tractive efforts and/or braking efforts of the vehicle 104. For example, the control system 114 may include an output device, such as a computer monitor, touchscreen, acoustic speaker, or the like, that generates visual and/or audible instructions based on the control signals. The instructions may direct the operator to change throttle settings and/or brake settings of the propulsion subsystem 116.

The control system 114 may form a trip plan for a trip of the vehicle 104 to travel to a scheduled destination location at a scheduled arrival time. The trip plan may include throttle settings, brake settings, designated speeds, or the like, of the vehicle 104 for various sections of the trip of the vehicle 104. For example, the trip plan can include one or more velocity curves that designate various speeds of the vehicle 104 along various sections of the routes 102. The trip plan can be used by the control system 114 to determine the tractive efforts and/or braking efforts of the propulsion subsystem 116 for the trip. The control system 114 may form the control signals based on the trip plan.

In one embodiment, the trip plan is formed by the control system 114 to reduce at least one of an amount of fuel that is consumed by the vehicle 104 and/or an amount of emissions generated by the vehicle 104 as the vehicle 104 travels to the destination location associated with the received schedule. The control system 114 may create a trip plan having throttle settings, brake settings, designated speeds, or the like, that propels the vehicle 104 to the scheduled destination location in a manner that consumes less fuel and/or produces less emissions than if the vehicle 104 traveled to the scheduled destination location in another manner. As one example, the vehicle 104 may consume less fuel and/or generate fewer emissions in traveling to the destination location according to the trip plan than if the vehicle 104 traveled to the destination location while traveling at another predetermined speed, such as the maximum allowable speed of the routes 102 (which may be referred to as “track speed”). The trip plan may result in the vehicle 104 arriving at the scheduled destination later than the scheduled arrival time. For example, following the trip plan may cause the vehicle 104 to arrive later than the scheduled arrival time, but within a predetermined range of time after the scheduled arrival time.

The trip plan for one or more of the vehicles 104 may represent control information that is used to control movement of the one or more of the vehicles 104. In one embodiment, the control information may include other data or information related to movement of the vehicles 104, such as previous throttle and/or brake settings that are stored in a log by the control system 114. The control information may be used by another system, such as the scheduling system 110 and/or the travel system 112, to change information generated by the scheduling system 110 and/or the travel system 112. For example, the scheduling system 110 may examine control information that includes a trip plan of a vehicle 104. Based on the trip plan, the scheduling system 110 may modify the schedules of one or more other vehicles 104 in the transportation network 100. For example, if the trip plan may cause a first vehicle 104 to interfere with the travel of one or more other vehicles 104 toward respective scheduled destination locations, then the scheduling system 110 can modify the schedules of the other vehicles 104 to avoid interference from the first vehicle 104.

In the illustrated embodiment, a communication unit 118 is communicatively coupled with the scheduling system 110, the travel system 112, and/or the control systems 114 of the vehicles 104. By “communicatively coupled,” it is meant that the communication unit 118 can communicate data signals that include information with one or more of the scheduling system 110, the travel system 112, and/or the control systems 114 using one or more wired and/or wireless connections. For example, the communication unit 118, the scheduling system 110, the travel system 112, and the control systems 114 may be coupled with respective antennas 120, 122, 124, 126, such as radio frequency (RF) or cellular antennas, that wirelessly communicate information between the communication unit 118, the scheduling system 110, the travel system 112, and/or the control systems 114 of the vehicles 104. Alternatively, the communication unit 118 may be coupled with one or more of the scheduling system 110, the travel system 112, and/or one or more of the control systems 114 by one or more conductive pathways through which information is communicated, such as wires, cables, and/or rails of the route 102.

As described below, the communication unit 118 coordinates communication of information between the scheduling system 110, the travel system 112, and/or the control systems 114 of the vehicles 104. For example, the communication unit 118 may act as a communication gateway through which information (e.g., schedule information from the scheduling system 110, safety information from the travel system 112, and/or control information from the vehicles 104) is communicated between the scheduling system 110, the travel system 112, and/or the control systems 114. In one embodiment, two or more of the scheduling system 110, the travel system 112, and/or the control system 114 of a vehicle 104 use different communication formats or protocols to communicate information. For example, the scheduling system 110 and the control system 114 may be manufactured or installed by different parties that use different communication formats. The communication unit 118 may determine the communication formats of data messages transmitted by the scheduling system 110 or the control system 114 and convert the format of the message to the format used by the other of the scheduling system 110 and the control system 114.

The communication unit 118 may control the timing at which information is communicated between the scheduling system 110, the travel system 112, and/or the control system 114 of one or more vehicles 104. One or more of the scheduling system 110, the travel system 112, and/or the control system 114 of one or more vehicles 104 may receive and act on information received in a designated order. For example, the scheduling system 110 may receive safety information from the travel system 112 prior to receiving other information (e.g., destination locations and/or priorities of the vehicles 104) that is used to generate the schedules for the vehicles 104. If the scheduling system 110 receives the other information prior to the safety information, the scheduling system 110 may create inefficient schedules that are based predominantly on the other information and not the safety information.

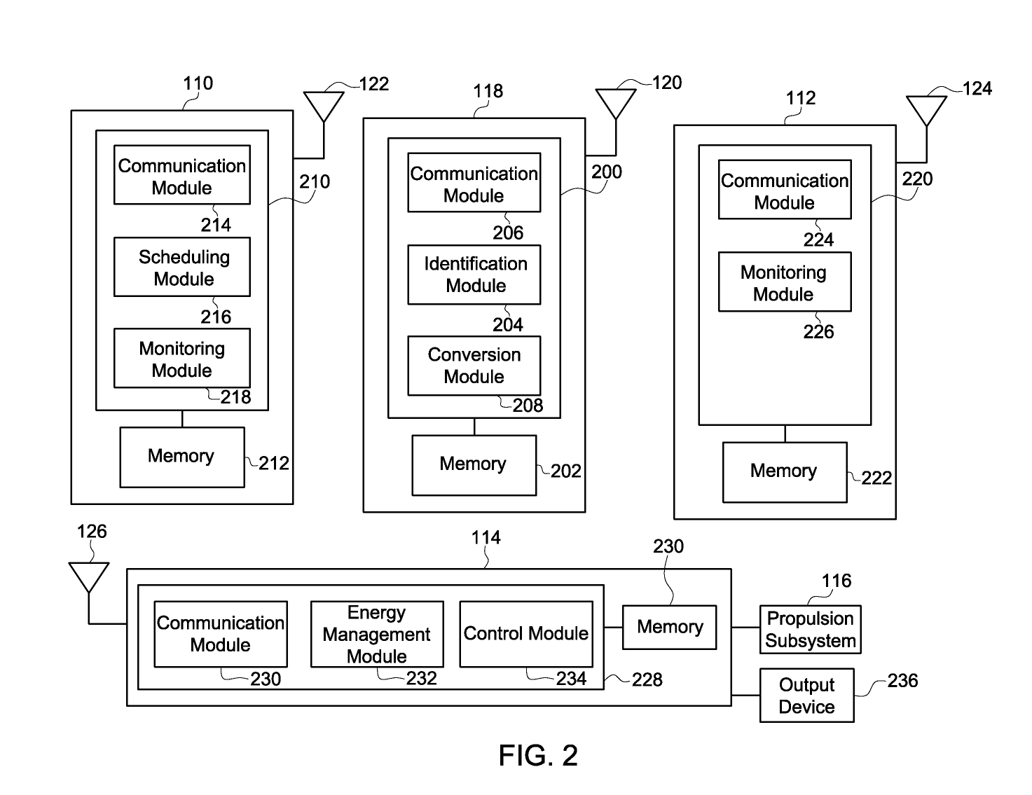

FIG. 2 is a schematic diagram of one embodiment of the communication unit 118. The scheduling system 110, the travel system 112, and the control system 114 of a vehicle 104 (shown in FIG. 1) also are shown in FIG. 2. While the communication unit 118 is shown communicating with a single scheduling system 110, a single travel system 112, and a single control system 114, alternatively, the communication unit 118 may concurrently communicate with a plurality of scheduling systems 110, a plurality of travel systems 112, and/or a plurality of control systems 114.

The communication unit 118 includes a controller 200, such as a computer processor, controller, or other logic-based device that performs operations based on one or more sets of instructions (e.g., software). The instructions on which the controller 200 operates may be stored on a tangible and non-transitory (e.g., not a transient signal) computer readable storage medium, such as a memory 202. The memory 202 may include one or more computer hard drives, flash drives, RAM, ROM, EEPROM, and the like. Alternatively, one or more of the sets of instructions that direct operations of the controller 200 may be hard-wired into the logic of the controller 200, such as by being hard-wired logic formed in the hardware of the controller 200.

As described herein, the communication unit 118 may act as an applications programming interface (API) in one embodiment. For example, the communication unit 118 may provide the rules, protocols, specifications, and the like, that dictate how different systems (e.g., the systems 110, 112, 114) communicate with each other. The communication unit 118 may control the formats of the data messages that are communicated between the systems 110, 112, 114 and/or the timing at which the data messages are communicated, as described below.

The communication unit 118 includes several modules that perform various operations described herein. As used herein, the term “module” includes a hardware and/or software system that operates to perform one or more functions. For example, a module may include a computer processor, controller, or other logic-based device that performs operations based on instructions stored on a tangible and non-transitory computer readable storage medium, such as a computer memory. Alternatively, a module may include a hard-wired device that performs operations based on hard-wired logic of the device. The modules shown in the attached figures may represent the hardware that operates based on software or hardwired instructions, the software that directs hardware to perform the operations, or a combination thereof.

The modules are shown as being included in the controller 200. Alternatively, one or more of the modules may include a controller that is separate from the controller 200. For example, a single processor (or other logic-based device) may perform the functions associated with the modules shown in the controller 200 of FIG. 2 or multiple processors (and/or other logic-based devices) may perform the functions associated with the modules.

A communication module 206 controls the communication of information to and/or from the communication unit 118. For example, the communication module 206 may be communicatively coupled with the antenna 120 by one or more wired and/or wireless connections to transmit and/or receive data messages (e.g., data signals) to and/or from the scheduling system 110, travel systems 112, and/or the control systems 114. In another embodiment, the communication module 206 may be communicatively coupled with one or more of the systems (e.g., the travel system 112, scheduling system 110, control system 114, or other system) by one or more wired connections. The communication module 206 may include or be coupled with hardware and/or circuitry that controls communication with the communication unit 118, such as transceivers, transmitters, receivers, or the like.

The communication module 206 receives information, such as data included in data messages transmitted from one or more of the scheduling system 110, the travel system 112, and/or the control systems 114. The communication module 206 may receive scheduling information (e.g., schedules) for the vehicles 104 (shown in FIG. 1) from the scheduling system 110, safety information from the travel system 112, and/or control information (e.g., trip plans) from the control systems 114.

An identification module 204 determines a format of the data messages that are received by the communication module 206. In one embodiment, the formats of data messages received from two or more of the scheduling system 110, the travel system 112, and/or the control systems 114 differ from each other. For example, one or more of the scheduling system 110, the travel system 112, and/or the control systems 114 may use different communication protocols that communicate and/or understand data messages arranged in different formats.

The different formats used by different ones of the scheduling system 110, the travel system 112, and/or the control systems 114 may be open or closed formats. A “format” of data messages can represent the syntax in which information or data is recorded, read, and/or communicated in the data messages. For example, the format of a communication protocol may be based on a syntax of the protocol, such as one or more rules that define how various combinations of symbols, alphanumeric text, binary bits (e.g., 0's and 1's), and the like, are combined and used to represent and communicate data between a transmitter and a recipient that are communicating using the protocol.

An “open format” includes a format that can be read (e.g., received and able to be used to perform one or more functions) by a plurality of different systems (e.g., the scheduling system 110, the travel system 112, and/or the control systems 114) provided by different manufacturers or suppliers and/or that use different communication protocols to communicate and process data. Data communicated in an open format may be implemented (e.g., read, communicated, saved, used to perform a function, and the like) by both proprietary software or modules and open (e.g., open source) software or modules. An open format can be a format whose rules of syntax are publicly available, or at least provided by an entity that controls or owns the open format to one or more other entities. In one embodiment, an open format represents a format of data that is defined by one or more industry or standards organization for a variety of different entities (e.g., different persons, corporations, and the like) to use to communicate the data. Alternatively, an open format includes a format that is able to be used (e.g., to read and communicate data) by a recipient of the data that is different from the transmitter of the data. In another embodiment, an “open format” may include a format that is based on an open source format of communicating the data.

A “closed format” can include a format that may not be used (e.g., to read or communicate data) by other entities unless the other entities are granted access to details regarding the rules, syntax, and the like, of the format. For example, a closed format may be a proprietary format of a first entity that cannot be used by other entities without the first entity providing the rules and syntax of the format to the other entities. Data communicated in a closed format may be unable to be implemented by proprietary software or modules that use a different format and/or open (e.g., open source) software or modules that use an open format. A closed format can be a format whose rules of syntax are not publicly available.

The identification module 204 can determine the format of data messages received from the systems. For example, when a data message including schedule information (e.g., a schedule for a vehicle 104 shown in FIG. 1) is received from the scheduling system 110, the identification module 204 may determine the format of the data message. In one embodiment, the identification module 204 may extract or parse out one or more subsets of the data or information (e.g., one or more bits) included in the data message to determine the format of the message. The data messages may be transmitted in data packets (e.g., as network data) having header sections, footer sections, or other sections that include information about the data messages. This information may include an identification of the format or protocol used to communicate the data message. Alternatively, the identification module 204 may extract or parse out a sample subset of the data message and compare the sample subset to one or more samples of data packets or data messages saved on the memory 202. If the sample subset of the data message matches a sample stored on the memory 202 (e.g., by at least a predesignated percentage or number of bits in the sample subset matching the sample stored in the memory 202), then the identification module 204 may determine that the data message is communicated in a format that is associated with the sample stored in the memory 202.

The identification module 204 may examine the data message to determine the destination of the data message. For example, the data message may be sent through the communication unit 118 from one system (such as the scheduling system 110) to another system (such as the control system 114). The data message may be addressed to the system to which the data message is sent or intended to be sent by the system that transmitted the data message. For example, if the travel system 112 transmits a data message to the scheduling system 110 through the communication unit 118, then the travel system 112 may address the data message to the scheduling system 110. The system to which a data message is addressed can be referred to as an addressed system. One system may address a data message to another system by including an identification or unique identifier of the system that is to receive the data message in the data message. For example, a header or footer of a data packet of the data message may include an alphanumeric or numeric string that identifies the system to which the data message is addressed.

In another embodiment, the data message may be addressed to a type or category of system instead of to a specific system. For example, the travel system 112 and/or control system 114 may transmit safety information or control information to a scheduling system that is communicatively coupled with the communication unit 118, but not necessarily to a specific scheduling system. As a vehicle 104 (shown in FIG. 1) travels through one or more transportation networks, the vehicle 104 may communicate with a plurality of different scheduling systems 110 that may be provided by different manufacturers or installers. The control system 114 of the vehicle 104 may be unaware of which scheduling system 110 to which the control system 114 is transmitting data messages. Instead, the control system 114 may transmit control information in data messages to the communication unit 118, which sends the data messages to the scheduling system 110 that generates schedules for the vehicles 104 traveling in an associated transportation network.

The identification module 204 may determine if the format of the received data message is compatible with the system to which the data message is addressed. For example, the identification module 204 may receive control information from the control system 114 of a vehicle 104 (shown in FIG. 1) in a data message that is in a first format. The data message may be addressed to the scheduling system 110 (e.g., a trip plan that is used by the scheduling system 110 to modify the schedules of one or more other vehicles 104) or to the travel system 112 (e.g., a notification of a damaged section of a route that needs to have repair scheduled by the travel system 112). The identification module 204 can determine the system that is to receive the data message (e.g., the scheduling system 110 or the travel system 112 in the preceding example), as described above. The identification module 204 may determine the one or more formats or protocols that are compatible with the addressed system, such as those formats that can used or can be used by addressed system to receive and/or transmit information in data messages. For example, the identification module 204 may refer to a list, table, database, or other structure of information that is stored on the memory 202 and that associates different addressed systems with the formats of data messages that can be received and understood (e.g., interpreted) by the addressed systems. Alternatively, the data message may include an identification of the format or formats that are compatible (e.g., able to be understood or interpreted) with the addressed system.

A conversion module 208 changes the format of the data message that is received by the communication unit 118 for transmission to the system that is addressed by the data message. For example, if the data message received by the communication unit 118 is incompatible with the addressed system (e.g., the information in the data message cannot be read or interpreted by the addressed system due to an incompatible format of the data message), then the conversion module 208 may change the format of the data message to a format that is compatible with the addressed system. Alternatively, the conversion module 208 may parse out or extract a portion of the information (e.g., one or more bits) in the data message and form a data message that includes the parsed out or extracted information and that is in a format that is compatible with the addressed system.

In one embodiment, the conversion module 208 converts the format of a data message by changing a syntax of a set of bits of the data included in the data message. As another example of such conversion, the conversion module 208 can unpack or extract one or more subsets of bits of the data in a received data message for inclusion into a different, second data message that includes the one or more subsets of bits of the data and that is sent to the addressed system. The above examples are not all inclusive as additional conversion mechanisms may be used by the conversion module 208.

The conversion module 208 can change a format of a data message by altering the order in which information is included in the data message in one embodiment. The conversion module 208 may change the order of bits or subsets of bits in a data packet of a data message and/or change the order of data packets in a data message. As one example, the scheduling system 110 may be configured to receive control information from control systems 114 of the vehicles 104 (shown in FIG. 1) in a first order, such as the identification of the vehicle 104 that generated the control information, followed by identifications of operational settings (e.g., speed) of the vehicle 104 for various locations of a trip of the vehicle 104 (e.g., for a trip plan of the vehicle 104), followed by the corresponding locations at which the operational settings of the vehicle 104 change during a trip plan. The control system 114 of the vehicle 104, however, may transmit the control information in a different order, such as by not including the identification of the vehicle 104 in the data message or not placing the identification before the operational settings or locations, by switching the order of the operational settings and locations in the data message, and the like. The conversion module 208 may change the order in which the information is included in the data message and/or append information to the data message (e.g., by adding the identification of the vehicle 104 or control system 114). For example, the conversion module 208 may change the order of information in the data message to an order that is used by the addressed system.

The conversion module 208 can reformat a data message by combining data messages from two or more systems. The conversion module 208 may include information from data messages sent from two or more scheduling systems 110, travel systems 112, and/or control systems 114 into a single data message that is sent to an addressed system. For example, the conversion module 208 may combine data messages (or portions thereof) from the travel system 112 and one or more control systems 114 into a converted data message that is sent to an addressed system (e.g., a data message that includes safety information concerning the locations of section of the routes that are under repair and one or more trip plans of one or more vehicles 104). As described above, the conversion module 208 may change an order of the information in the converted data message to match an order that the addressed system expects to receive the information in a data message.

The conversion module 208 may convert the format of the data message (or a portion thereof) from a closed format to an open format. The data message may be communicated in a closed format from a transmitting system to the communication unit 118. For example, the scheduling system 110 may transmit scheduling information, the travel system 112 may transmit safety or other information, or the control system 114 may transmit control information to the communication unit 118 in a first closed format. The identification module 204 can determine the closed format of the data message and determine that the addressed system to which the data message is addressed uses a different, open format to receive and/or read data in data messages. The conversion module 208 converts the data (or a portion thereof) from the closed format to the open format. For example, the conversion module 208 may read the information in the closed format of the data message and modify the data message or form another data message in open format used by the addressed system. The reformatted data message (e.g., the message in the open format) may include all or a portion of the same information included in the data message of the closed format, but in the different open format. The reformatted data message is conveyed to the communication module 206, which transmits the data message in the open format to the addressed system (e.g., the scheduling system 110, the travel system 112, and/or the control system 114).

Alternatively, the conversion module 208 can convert the format of a data message received by the communication unit 118 from an open format to a closed format. The data message may be transmitted from a system (e.g., the scheduling system 110, the travel system 112, and/or the control system 114) to the communication unit 118 in an open format. The identification module 204 of the communication unit 118 determines the format of the received data message and the format or formats that are compatible with the system to which the data message is addressed, as described above. The conversion module 208 can reformat the information in the data message into a data message in the closed format that is compatible with the addressed system. The communication module 206 may then transmit the reformatted data message in the closed format to the addressed system (e.g., the scheduling system 110, the travel system 112, and/or the control system 114).

In another embodiment, the conversion module 208 can convert the format of a data message received by the communication unit 118 from a first closed format to a different, second closed format. The data message may be transmitted from a first system in the first closed format (e.g., a proprietary format of a first entity that provided the first system) to the communication unit 118. The identification module 204 identifies the first closed format of the data message and the second closed format that is used by the addressed system of the data message. The conversion module 208 changes the format of the received data message to the second closed format and the communication module 206 sends the reformatted data message to the addressed system.

The scheduling system 110 includes a controller 210, such as a computer processor, controller, or other logic-based device that performs operations based on one or more sets of instructions (e.g., software). The instructions on which the controller 210 operates may be stored on a tangible and non-transitory (e.g., not a transient signal) computer readable storage medium, such as a memory 212. The memory 212 may include one or more computer hard drives, flash drives, RAM, ROM, EEPROM, and the like. Alternatively, one or more of the sets of instructions that direct operations of the controller 210 may be hard-wired into the logic of the controller 210, such as by being hard-wired logic formed in the hardware of the controller 210.

The scheduling system 110 includes several modules that perform various operations described herein. The modules are shown in FIG. 2 as being included in the controller 210, but alternatively may be embodied in a controller that is separate from the controller 210. For example, a single processor (or other logic-based device) may perform the functions associated with the modules shown in the controller 210 or multiple processors (and/or other logic-based devices) may perform the functions associated with the modules.

The scheduling system 110 includes a communication module 214 that may be similar to the communication module 206 of the communication unit 118. For example, the communication module 214 may control the communication of information to and/or from the scheduling system 110 via the antenna 122 and/or one or more wired connections.

The scheduling system 110 includes a scheduling module 216 that creates schedules for the vehicles 104 (shown in FIG. 1). The scheduling module 216 can form the movement plan for the transportation network 100 (shown in FIG. 1) that coordinates the schedules of the various vehicles 104 traveling in the transportation network 100. For example, the scheduling module 216 may generate schedules for the vehicles 104 that are based on each other so that a throughput parameter of the transportation network 100 remains above a threshold. The throughput parameter can represent the flow or movement of the vehicles 104 through the transportation network 100 or a subset of the transportation network 100. In one embodiment, the throughput parameter can indicate how successful the vehicles 104 are in traveling according to the schedule associated with each vehicle 104. For example, the throughput parameter can be a statistical measure of adherence by one or more of the vehicles 104 to the schedules of the vehicles 104 in the movement plan. The term “statistical measure of adherence” can refer to a quantity that is calculated for a vehicle 104 and that indicates how closely the vehicle 104 is following the schedule associated with the vehicle 104. Several statistical measures of adherence to the movement plan may be calculated for the vehicles 104 traveling in the transportation network 100.

In one embodiment, larger throughput parameters represent greater flow of the vehicles 104 through the transportation network 100, such as what may occur when a relatively large percentage of the vehicles 104 adhere to the associated schedules and/or the amount of congestion in the transportation network 100 are relatively low. Conversely, smaller throughput parameters may represent reduced flow of the vehicles 104 through the transportation network 100. The throughput parameter may reduce in value when a lower percentage of the vehicles 104 follow the associated schedules and/or the amount of congestion in the transportation network 100 is relatively large. Examples of how the throughput parameter may be calculated are described below.

The scheduling module 216 can create and/or modify the schedules of the vehicles 104 (shown in FIG. 1) such that one or more throughput parameters of the vehicles 104 traveling in the transportation network 100 (shown in FIG. 1) are maintained above a predetermined non-zero threshold. For example, the scheduling module 216 can coordinate the initial schedules such that the congestion (e.g., density per unit area over a time window) of the vehicles 104 in one or more portions of the transportation network 100 remains relatively low such that the flow of the vehicles 104 in or through the transportation network 100 is relatively high.

The scheduling system 110 includes a monitoring module 218 in the illustrated embodiment. The monitoring module 218 can monitor travel of the vehicles 104 (shown in FIG. 1) in the transportation network 100 (shown in FIG. 1). The vehicles 104 may periodically report current positions of the vehicles 104 to the scheduling system 110 so that the monitoring module 218 can track where the vehicles 104 are located. Alternatively, signals or other sensors disposed alongside the routes 102 (shown in FIG. 1) of the transportation network 100 can periodically report the passing of vehicles 104 by the signals or sensors to the scheduling system 110. The monitoring module 218 receives the locations of the vehicles 104 in order to monitor where the vehicles 104 are in the transportation network 100 over time.

The monitoring module 218 may determine the throughput parameters of the transportation network 100 (shown in FIG. 1) and/or areas of the transportation network 100 that are used by the scheduling module 216 to coordinate the schedules of the vehicles 104 (shown in FIG. 1). The monitoring module 218 can calculate the throughput parameters based on the schedules of the vehicles 104 and deviations from the schedules by the vehicles 104. For example, in order to determine a statistical measure of adherence to the schedule associated with a vehicle 104, the monitoring module 218 may monitor how closely the vehicle 104 adheres to the schedule as the vehicle 104 travels in the transportation network 100 (shown in FIG. 1). The vehicle 104 may adhere to the schedule of the vehicle 104 by proceeding along a path toward the scheduled destination such that the vehicle 104 will arrive at the scheduled destination at the scheduled arrival time. For example, an estimated time of arrival (ETA) of the vehicle 104 may be calculated as the time that the vehicle 104 will arrive at the scheduled destination if no additional anomalies occur that change the speed at which the vehicle 104 travels. If the ETA is the same as or within a predetermined time window of the scheduled arrival time, then the monitoring module 218 may calculate a large statistical measure of adherence for the vehicle 104. As the ETA differs from the scheduled arrival time (e.g., by occurring after the scheduled arrival time), the statistical measure of adherence may decrease.

Alternatively, the vehicle 104 (shown in FIG. 1) may adhere to the schedule by arriving at or passing through scheduled waypoints of the schedule at scheduled times that are associated with the waypoints, or within a predetermined time buffer of the scheduled times. As differences between actual times that the vehicle 104 arrives at or passes through the scheduled waypoints and the associated scheduled times of the waypoints increases, the statistical measure of adherence for the vehicle 104 may decrease. Conversely, as these differences decrease, the statistical measure of adherence may increase.

The monitoring module 218 may calculate the statistical measure of adherence as a time difference between the ETA of a vehicle 104 (shown in FIG. 1) and the scheduled arrival time of the schedule associated with the vehicle 104. Alternatively, the statistical measure of adherence for the vehicle 104 may be a fraction or percentage of the scheduled arrival time. For example, the statistical measure of adherence may be the fraction or percentage that the difference between the ETA and the scheduled arrival time is of the scheduled arrival time. In another example, the statistical measure of adherence may be a number of scheduled waypoints in a schedule of the vehicle 104 that the vehicle 104 arrives at or passes by later than the associated scheduled time or later than a time window after the scheduled time. Alternatively, the statistical measure of adherence may be a sum total, average, median, or other calculation of time differences between the actual times that the vehicle 104 arrives at or passes by scheduled waypoints and the associated scheduled times.

The differences between when the vehicle 104 arrives at or passes through one or more scheduled locations and the time that the vehicle 104 was scheduled to arrive at or pass through the scheduled locations may be used to calculate the statistical measure of adherence to a schedule for the vehicle 104. In one embodiment, the statistical measure of adherence for the vehicle 104 may represent the number or percentage of scheduled locations that the vehicle 104 arrived too early or too late. For example, the monitoring module 218 may count the number of scheduled locations that the vehicle 104 arrives at or passes through outside of a time buffer around the scheduled time. The time buffer can be one to several minutes. By way of example only, if the time buffer is three minutes, then the monitoring module 218 may examine the differences between the scheduled times and the actual times and count the number of scheduled locations that the vehicle 104 arrived more than three minutes early or more than three minutes late. Alternatively, the monitoring module 218 may count the number of scheduled locations that the vehicle 104 arrived early or late without regard to a time buffer. In another embodiment, the monitoring module 218 may calculate the statistical measure of adherence by the vehicle 104 to the schedule based on the total or sum of time differences between the scheduled times associated with the scheduled locations and the actual times that the vehicle 104 arrived at or passed through the scheduled locations. In another embodiment, the monitoring module 218 may calculate the average statistical measure of adherence by comparing the deviation of each vehicle 104 from the average or median statistical measure of adherence of the several vehicles 104 traveling in the transportation network 100. For example, the monitoring module 218 may calculate an average or median deviation of the measure of adherence for the vehicles 104 from the average or median statistical measure of adherence of the vehicles 104.

The monitoring module 218 may determine the throughput parameters for the transportation network 100 (shown in FIG. 1), or an area thereof, based on the statistical measures of adherence associated with the vehicles 104 (shown in FIG. 1). For example, a throughput parameter may be an average, median, or other statistical calculation of the statistical measures of adherence for the vehicles 104 concurrently traveling in the transportation network 100. The throughput parameter may be calculated based on the statistical measures of adherence for all, substantially all, a supermajority, or a majority of the vehicles 104 traveling in the transportation network 100.

The scheduling module 216 creates the schedules for the vehicles 104 (shown in FIG. 1) and transmits the schedules to the control systems 114 of the vehicles 104 via the communication unit 114. As described above, the control systems 114 may use the schedules to determine trip plans for the vehicles 104 to travel to scheduled destination locations. In one embodiment, the scheduling module 216 may transmit one or more schedules to the travel system 112 via the communication unit 118. The scheduling module 216 may send one or more of the schedules to the travel system 112 so that the travel system 112 can use the schedules to form or modify safety information generated by the travel system 112. For example, the travel system 112 may examine the schedules of several vehicles 104 to determine if the number of vehicles 104 in an area of the transportation network 100 (shown in FIG. 1) is greater than a predesignated threshold and may present a safety problem for travel of additional vehicles 104 in that area.

The travel system 112 includes a controller 220, such as a computer processor, controller, or other logic-based device that performs operations based on one or more sets of instructions (e.g., software). The instructions on which the controller 220 operates may be stored on a tangible and non-transitory (e.g., not a transient signal) computer readable storage medium, such as a memory 222. The memory 222 may be similar to the memory 202 and/or 212. Alternatively, one or more of the sets of instructions that direct operations of the controller 220 may be hard-wired into the logic of the controller 220.

The travel system 112 includes several modules that perform various operations described herein. The modules are shown in FIG. 2 as being included in the controller 220, but alternatively may be embodied in a controller that is separate from the controller 220. The travel system 112 includes a communication module 224 that may be similar to the communication module 206 of the communication unit 118 and/or the communication module 214 of the scheduling system 110. For example, the communication module 224 may control the communication of information to and/or from the travel system 112 via the antenna 124 and/or one or more wired connections.

The travel system 112 includes a monitoring module 226 that monitors one or more conditions of the transportation network 100 (shown in FIG. 1) in order to generate the information that is transmitted from the travel system 112 to one or more other systems. For example, the monitoring module 226 may track the locations of where sections of the routes in the transportation network 100 are under repair, the locations of damaged sections of the routes, the locations of where broken down vehicles 104 (e.g., vehicles 104 that are unable to move due to mechanical failure or other problems such as derailment), the locations of where repair vehicles are located, and the like. The monitoring module 226 may transmit this information as safety information in data messages that are transmitted to the scheduling system 110 and/or the control systems 114 of one or more vehicles 104 (shown in FIG. 1) via the communication unit 118.

In one embodiment, the travel system 112 can transmit the safety information to the scheduling system 110 so that the scheduling system 110 can create and/or modify one or more schedules of the vehicles 104 (shown in FIG. 1) based on the safety information. For example, the travel system 112 may transmit the locations of sections of the routes that are under repair so that the scheduling system 110 can account for reduced speed limits at or near the sections under repair and/or generate or modify schedules so that the vehicles 104 do not travel across the sections under repair.

The travel system 112 can transmit the safety information to the control systems 114 of one or more vehicles 104 (shown in FIG. 1) so that the vehicles 104 can adjust travel of the vehicles 104 according to the safety information. For example, the travel system 112 can be or include a PTC safety system that transmits information such as restricted areas where the vehicles 104 are not permitted to travel (e.g., due to repair of the routes, locations of pedestrians, and the like), speed limits to prevent the vehicles 104 from traveling too fast in areas that are relatively heavily congested with other vehicles 104 and/or persons, and the like.

The control systems 114 of one or more of the vehicles 104 (shown in FIG. 1) include a controller 228, such as a computer processor, controller, or other logic-based device that performs operations based on one or more sets of instructions (e.g., software). The instructions on which the controller 228 operates may be stored on a tangible and non-transitory (e.g., not a transient signal) computer readable storage medium, such as a memory 230. The memory 230 may be similar to the memory 202, 212, and/or 222. Alternatively, one or more of the sets of instructions that direct operations of the controller 228 may be hard-wired into the logic of the controller 228.

The control system 114 includes several modules that perform various operations described herein. The modules are shown in FIG. 2 as being included in the controller 228, but alternatively may be embodied in a controller that is separate from the controller 228. The control system 114 includes a communication module 230 that may be similar to the communication module 206 and/or 210 described above. For example, the communication module 230 may control the communication of information to and/or from the control system 114 via the antenna 126 and/or one or more wired connections.

The control system 114 includes an energy management module 232 that forms a trip plan for the vehicle 104 (shown in FIG. 1). In another embodiment, the energy management module 232 may be disposed off-board the vehicle 104 for which the trip plan is formed. The energy management module 232 receives scheduling information, safety information, and/or other information sent from one or more the scheduling system 110 and the travel system 112 via the communication unit 118 and generates a trip plan based on the received information. As described above, the trip plan may include designated speeds of the vehicle 104 for various sections of a scheduled trip of the vehicle 104 to the scheduled destination location. The trip plan may be generated to reduce the amount of fuel that is consumed by the vehicle 104 and/or the amount of emissions generated by the vehicle 104 as the vehicle 104 travels to the destination location relative to travel by the vehicle 104 to the destination location when not abiding by the trip plan.

In order to generate the trip plan for the vehicle 104 (shown in FIG. 1), the energy management module 232 can refer to a trip profile that includes information related to the vehicle 104, information related to the routes over which the vehicle 104 travels to arrive at the scheduled destination, and/or other information related to travel of the vehicle 104 to the scheduled destination location at the scheduled arrival time. The information related to the vehicle 104 may include information regarding the fuel efficiency of the vehicle 104 (e.g., how much fuel is consumed by the vehicle 104 to traverse different sections of one or more routes), the tractive power (e.g., horsepower) of the vehicle 104, the weight or mass of the vehicle 104 and/or cargo, the length and/or other size of the vehicle 104, the location of the powered units 106 (shown in FIG. 1) in the vehicle 104 (e.g., front, middle, back, or the like of a vehicle consist having several mechanically interconnected units 106, 108), or other information. The information related to the route 102 to be traversed by the vehicle 104 can include the shape (e.g., curvature), incline, decline, and the like, of various sections of the route 102, the existence and/or location of known slow orders or damaged sections of the route 102, and the like. Other information can include information that impacts the fuel efficiency of the vehicle 104, such as atmospheric pressure, temperature, and the like.

The trip plan is formulated by the energy management module 214 based on the trip profile. For example, if the trip profile requires the vehicle 104 (shown in FIG. 1) to traverse a steep incline and the trip profile indicates that the vehicle 104 is carrying significantly heavy cargo, then the energy management module 232 may form a trip plan that includes or dictates increased tractive efforts to be provided by the propulsion subsystem 118 of the vehicle 104. Conversely, if the vehicle 104 is carrying a smaller cargo load and/or is to travel down a decline in the routes to be traversed by the vehicle 104 based on the trip profile, then the energy management module 232 may form a trip plan that includes or dictates decreased tractive efforts by the propulsion subsystem 116 for that segment of the trip. In one embodiment, the energy management module 232 includes a software application or system such as the Trip Optimizer™ system provided by General Electric Company.

The control system 114 includes a control module 234 that generates control signals for controlling operations of the vehicle 104 (shown in FIG. 1). The control module 234 may receive the trip plan from the energy management module 232 and generate control signals that automatically change the tractive efforts and/or braking efforts of the propulsion subsystem 116 based on the trip plan. For example, the control module 234 may form the control signals to automatically match the speeds of the vehicle 104 with the speeds directed by the trip plan for various sections of the trip of the vehicle 104 to the scheduled destination location. Alternatively, the control module 234 may form control signals that are conveyed to an output device 236 disposed on-board the vehicle 104. The output device 236 can visually and/or audibly present instructions to an operator of the vehicle 104 to change the tractive efforts and/or braking efforts of the vehicle 104 based on the control signals. For example, the output device 236 can include a monitor or touchscreen that visually presents textual instructions to the operator to increase or decrease the speed of the vehicle 104 to match a designated speed of the trip plan. The output device 236 may include a speaker that sounds alarms or provides voice directions to the operator to change the tractive efforts and/or braking efforts.

As described above, the systems 110, 112, 114 may communicate information between one other through the communication unit 118 to coordinate travel of the vehicles 104 (shown in FIG. 1) in the transportation network 100 (shown in FIG. 1). The communication unit 118 can allow the different systems 110, 112, 114, which may use different communication formats and/or protocols, to communicate the information between the systems 110, 112, 114 in order to control and/or coordinate travel of the vehicles 104.

In another embodiment, the amount of information that can be communicated among or between the systems 110, 112, 114 may be limited. For example, where two or more of the systems 110, 112, 114 wirelessly communicate with each other directly (e.g., not communicating messages through the communication unit 118) or indirectly (e.g., communicating messages through the communication unit 118), the amount of data that can be communicated in the data messages that are communicated may be limited. The limitation on the amount of data that can be communicated over a communication link between or among two or more of the systems 110, 112, 114 and/or the communication unit 118 per unit time may be referred to as a bandwidth limitation. Examples of bandwidth limitation include an amount of data (expressed in units of bytes, kilobytes, megabytes, and the like, or some other unit) per unit time (expressed in units of seconds or some other unit). The bandwidth limitation may be a result of a relatively large number of systems 110, 112, 114 using the same or similar communication links (e.g., wireless links at the same frequencies or frequencies that are close to one another, hard-wired or conductive pathways, and the like). The bandwidth limitation may represent an intrinsic limit on the amount of data that can be communicated over the communication link, whether that limit is affected by interference, communication congestion, and the like, or is not so affected. The bandwidth limitation may be input into one or more of the communication modules 206, 214, 224, 230 from an operator and/or may be measured or estimated by the communication modules 206, 214, 224, 230. For example, the communication modules 206, 214, 224, 230 may transmit packets of data between each other and/or through the communication unit 108 and measure transmission times for the packets (e.g,. round trip times between transmission of the packets and responses to the packets), how many packets do not receive responsive packets (e.g., “dropped” packets), and the like. These measurements or changes in the measurements may be associated with designated bandwidth limitations.

The data messages communicated between two or more of the systems 110, 112, 114 and/or the communication unit 118 may be limited or reduced based on the bandwidth limitation of the communication link between the two or more of the systems 110, 112, 114 and/or the communication unit 118. For example, when the communication link has a larger bandwidth limitation, the data messages that are communicated may be larger (e.g., include more bytes) and/or be communicated more frequently. When the bandwidth limitation is reduced, the data messages may be reduced in size (e.g., include fewer bytes) and/or be communicated less frequently.

As one example, if several vehicles 104 (shown in FIG. 1) are concurrently traveling in the same section (e.g., subsection or portion) of the transportation network 100 (shown in FIG. 1), the bandwidth limitation associated with communicating data messages with the control systems 114 of the vehicles 104 may not permit the communication of large data messages and/or relatively frequent communication of the data messages. For example, the bandwidth limitation may prevent the scheduling system 110 from frequently adjusting and communicating the schedules of the vehicles 104 to the control systems 114. Continuing to frequently communication and/or to communicate data messages that are too large may result in some of the data messages being “dropped,” such as by not being received by the addressed recipients of the data messages.

In order to reduce the size of the data messages and/or the frequency at which the data messages are communicated from the scheduling system 110 to the control systems 114, the communication module 214 of the scheduling system 110 may transmit a plan identifier representative of a designated trip plan to the control systems 114. The plan identifier may be a relatively small data message (e.g., a few bytes of data) that is received by the control systems 114 of the vehicles 104 (shown in FIG. 1). The control systems 114 may locally store one or more different, previously designated (e.g., calculated or otherwise created) trip plans for the vehicles 104, such as in or on the memories 230. The different trip plans may be associated with different plan identifiers. When the control systems 114 receive the plan identifier from the scheduling system 110, the control modules 234 of the control systems 114 may obtain the designated trip plan from the memories 230 based on the plan identifier and implement the trip plan in controlling movement of the vehicles 104, as described above. Communicating the plan identifier instead of the entire trip plan may consume or require less bandwidth of the communication link with the control systems 114 because less data (e.g., fewer bytes) may be communicated between the scheduling system 110 and the control systems 114.

Communicating the plan identifiers instead of entire schedules to the control systems 114 may allow the scheduling system 110 and the control systems 114 that use different communication formats, protocols, or the like, to communicate with one another. For example, instead of changing the formats of the data messages (e.g., schedules, trip plans, and the like) communicated between the scheduling system 110 and the control systems 114, the plan identifiers may be relatively small messages communicated in a format or protocol that is recognized or used by both the scheduling system 110 and the control systems 114. The plan identifiers may be communicated in a format, protocol, or language that is independent, accepted, or universal to the different formats, protocols, or languages used by the scheduling system 110 and one or more of the control systems 114.

The scheduling system 110 can communicate the plan identifier to the control systems 114 so that the control systems 114 of the vehicles 104 (shown in FIG. 1) in a subsection or portion of the transportation network 100 (shown in FIG. 1) follow the same trip plan in the transportation network 100. For example, the scheduling system 110 may broadcast the plan identifier to several vehicles 104 traveling relatively close together in a portion of the transportation network 100. These vehicles 104 may then travel according to the same trip plan. For example, the vehicles 104 may maintain or approximately maintain the same separation distances between each other as the vehicles 104 travel along the same route in the transportation network 100 by following the same trip plan. As a result, the vehicles 104 may travel at the same or similar speeds and prevent interfering with each other, such as what would occur when the vehicles 104 travel too close to each other.

Communicating the same plan identifier to the control systems 114 to cause the vehicles 104 (shown in FIG. 1) to travel according to the same trip plan may be used when several vehicles are traveling on the same route or routes in the transportation network 100 (shown in FIG. 1) and/or when the routes being traveled upon do not include siding section routes or other routes for the vehicles 104 to pass each other on. Following the same trip plan can cause the vehicles 104 to maintain approximately the same separation distance between each other and avoid the need for vehicles 104 to pass each other or otherwise deviate from the trip plan due to different vehicles 104 traveling at different speeds.

The scheduling system 110 may select previously designated trip plan to send to the control systems 114 of the vehicles 104 based on one or more operating characteristics of the vehicles 104. The operating characteristics may represent tractive output of the vehicles 104 (e.g., horsepower generated, top or maximum speed attainable, fuel efficiencies, and the like), braking capacities of the vehicles 104, sizes (e.g., masses and/or lengths) of the vehicles 104, and/or other measurements of the vehicles 104. In one embodiment, the control module 234 of the control system 114 can include or communicate with one or more sensors that monitor the operating characteristics of the vehicle 104. The communication module 234 of the control system 114 may transmit these operating characteristics to the scheduling system 110. Alternatively, the communication module 214 of the scheduling system 110 may be otherwise provided with the operating characteristics, such as by receiving the operating characteristics from an operator.

The monitoring module 218 of the scheduling system 110 can compare the operating characteristics of the vehicles 104 (shown in FIG. 1) that are concurrently traveling in the transportation network 100 with each other to determine if any of the operating characteristics indicate that one or more of the vehicles 104 are operating at a decreased level relative to one or more other vehicles 104. For example, the monitoring module 218 may determine, based on the comparison of the operating characteristics, if one or more of the vehicles 104 is producing or is only capable of producing less tractive effort (e.g., speed, horsepower, and the like), less braking effort, and the like, due to one or more factors, such as increased weight of the vehicle 104, increased size (e.g., length) of the vehicle 104, decreased output from one or more engines or motors of the vehicle 104, decreased brake air pressure, and the like.

Based on this comparison of the operating characteristics, the monitoring module 218 may notify the scheduling module 216 which vehicles 104 (shown in FIG. 1) are operating at a decreased level. The scheduling module 216 may then select a previously designated trip plan (e.g., from those stored in the memory 212) for the vehicles 104. Based on the selected trip plan, the communication module 214 may transmit or broadcast the plan identifier associated with the selected trip plan to the vehicles 104. In one embodiment, the scheduling module 216 selects a trip plan that does not require or involve one or more of the vehicles 104 to exceed a tractive effort capability (e.g., maximum or designated limit on speed or horsepower) and/or braking capacity of the vehicles 104. For example, if a first vehicle 104 is unable to travel at a first speed (even though other vehicles 104 are able to travel at the first speed), the scheduling module 216 may select a trip plan that does not include or require the vehicles 104 to travel at speeds greater than the first speed.

In another embodiment, the control system 114 of the vehicle 104 (shown in FIG. 1) determines which of a plurality of previously designated trip plans that the vehicle 104 has the ability or capacity to follow. For example, various vehicles 104 may be limited in the speeds at which the vehicles 104 can travel due to one or more mechanical limitations, such as size (e.g., length and/or weight) of the vehicles 104, health of the motors or engines of the vehicles 104, number and/or type of the motors or engines of the vehicles 104, number and/or type of the brakes in the vehicles 104, and the like. These mechanical limitations may be input into the communication module 230 (e.g., from an operator and/or from sensors coupled with the communication module 230) and communicated to the control module 234 of the control system 114.

Based on these mechanical limitations, the control module 234 may determine a subset of the previously designated trip plans that the vehicle 104 can travel according to without exceeding the mechanical limitations of the vehicle 104. For example, the control module 234 may examine a set of previously designated trip plan stored on the memory 230 and compare those trip plans with the mechanical limitations of the vehicle 104. If one or more of the trip plans do not require the vehicle 104 to travel at speeds that exceed the mechanical limitations of the vehicle 104, produce tractive or braking efforts that exceed the mechanical limitations of the vehicle 104, and the like, then the control module 234 may select those trip plans for inclusion in a selected subset of the trip plans. The control module 234 can provide the selected subset of trip plans to the communication module 230.

The communication module 230 can determine which plan identifiers are associated with the trip plans in the selected subset. Alternatively, the control module 234 can determine which plan identifiers are associated with the trip plans in the selected subset. The communication module 230 may then transmit the plan identifier or plan identifiers associated with the trip plans in the selected subset to the scheduling system 110. The communication module 214 of the scheduling system 110 may determine which previously designated trip plans are in the selected subset based on the information received from the control system 114. The scheduling module 216 may then select a previously designated trip plan from the selected subset of trip plans. The communication module 214 of the scheduling system 110 may then transmit or broadcast the plan identifier of the selected trip plan to the control systems 114 for use by the control systems 114.

In another embodiment, the scheduling system 110 may request capability update messages from the control systems 114 of the vehicles 104 (shown in FIG. 1) and select a previously designated trip plan for transmission to the vehicles 104 based thereon. A capability update message is a message sent from the control systems 114 to the scheduling system 110 that identifies one or more mechanical limits of the vehicles 104. When the control systems 114 receive the request for the capability update message from the scheduling system 110, the control modules 234 of the control systems 114 may obtain the mechanical limitations requested by the scheduling system 110 and send the capability update message with the requested mechanical limits of the associated vehicles 104. The monitoring module 218 of the scheduling system 110 may examine the received mechanical limitations of the vehicles 104 and select a previously designated trip plan. The selected trip plan may be a plan that does not require the vehicle 104 or vehicles 104 from exceeding the mechanical limits of the vehicles 104. The selected trip plan may then be sent by the communication module 214 to the control systems 114 for the vehicles 104 to follow, as described above. The contents of the requests for the capability update messages and/or the capability update messages may be relatively small (e.g., in terms of bytes, kilobytes, megabytes, and the like) such that the requests and the capability update messages may be communicated frequently and/or with relatively low bandwidth limitations on the communication links between the scheduling system 110 and the control systems 114.

In another embodiment, instead of transmitting entire schedules to the control systems 114 of the vehicles 104 (e.g., several locations and associated scheduled times for the vehicles 104 to travel to the corresponding locations), the scheduling system 110 may transmit a subset of a schedule to the control systems 114 when the bandwidth limitation of a communication link is relatively low. For example, instead of sending an entire schedule or several locations and associated scheduled arrival times at the locations, the scheduling system 110 may transmit fewer locations and arrival times to the control systems 114.

In one embodiment, the scheduling system 110 may transmit only a single location and scheduled arrival time to one or more of the control systems 114. For example, the scheduling system 110 may transmit the next location for the vehicle 104 (shown in FIG. 1) to travel toward and the associated arrival time to the control system 114 of the vehicle 104 when the bandwidth limitation is relatively low. When the vehicle 104 arrives at, comes close to, or passes the location, the scheduling system 110 may then send the next location and scheduled arrival time to the vehicle 104. Alternatively, the scheduling system 110 may periodically transmit the location and arrival time to the vehicle 104, such as by sending the location and arrival time every 30 seconds, 5 minutes, 30 minutes, or another value. This piecemeal or step-by-step communication of a schedule to the vehicle 104 may consume or require less bandwidth in a communication link between the scheduling system 110 and the control system 114 of the vehicle 104 when each next location and arrival time is transmitted then transmitting an entire or partial schedule that includes multiple locations and arrival times.

In another embodiment, the control system 114 may transmit only a portion or subset of a trip plan to the scheduling system 110. For example, the control system 114 may transmit a section of a trip plan (that is less than the entire or remainder of the trip plan) to the scheduling system 110 for the scheduling system 110 to use in modifying the schedules, as described above. The section of the trip plan may include the portion of the trip plan that corresponds to the next designated distance or time period that the vehicle 104 will travel along, such as the next 10, 20, 40, or 50 miles (or another value) or more. When the vehicle 104 travels through the portion of the trip plan that was transmitted, the control system 114 may then send the next portion of the trip plan to the scheduling system 110. Alternatively, the control system 114 may periodically send the next portion of the trip plan to the scheduling system 110. This piecemeal or step-by-step communication of a trip plan to the scheduling system 110 may consume or require less bandwidth in a communication link between the control system 114 and the scheduling system 110 when each portion of the trip plan is transmitted then transmitting an entire trip plan.

In another embodiment, the data that is included in data messages communicated between or among the systems 110, 112, 114 and/or the communication unit 108 may be based on the bandwidth limitation of one or more communication links. When the bandwidth limitation of a communication link falls below a first designated threshold, the systems 110, 112, 114 and/or the communication unit 108 may communicate designated sets of data or information at designated times. When the bandwidth limitation falls below a lower, second designated threshold, the systems 110, 112, 114 and/or the communication unit 108 may communicate different designated sets of data or information at designated times. For example, if the bandwidth limitation falls below the first threshold, the control systems 114 may only transmit current locations and times of the vehicles 104 (shown in FIG. 1), current speeds of the vehicles 104, and/or portions of trip plans of the vehicles 104. The scheduling system 110 may only transmit portions of the schedules or modified schedules to the vehicles 104. If the bandwidth limitation falls below the second threshold, the control systems 114 may only transmit current locations and times or the speeds of the vehicles 104, but not the portions of the trip plans. The scheduling system 110 may only transmit the next scheduled locations and arrival times, but not additional portions of the schedules. Other designated sets of information to be passed between the systems 110, 112, 114 and/or communication unit 108 may be associated with different bandwidth limitations.

In another embodiment, the communication unit 108 may filter what information is communicated between the systems 110, 112, 114 based on the bandwidth limitation of communication links between the communication unit 108 and one or more of the systems 110, 112, 114. For example, the communication unit 108 may monitor the bandwidth limitation of one or more of the communication links. If the bandwidth limitation falls below a designated threshold, then the communication unit 108 may restrict the data communicated between the systems 110, 112, 114 through the communication unit 108. For example, instead of transmitting entire schedules or trip plans, the communication unit 108 may receive the entire schedule or trip plan but only transmit a portion of the schedule or trip plan, as described above. The communication unit 108 may continue to send portions of the schedule or trip plan, as described above. When the bandwidth limitation increases, the communication unit 108 can increase how much data is transmitted between the systems 110, 112, 114 via the communication unit 108.

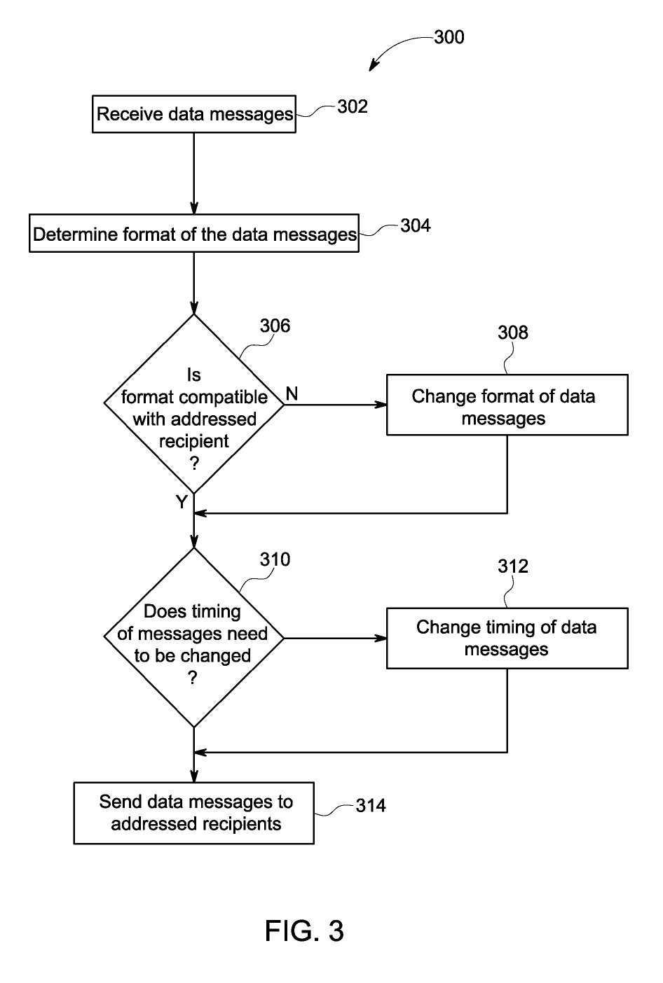

FIG. 3 is a flowchart of a method 300 for communicating information between systems in accordance with one embodiment. The method 300 may be used in conjunction with one or more embodiments of the communication unit 118 (shown in FIG. 1) described herein.

At 302, one or more data messages are received from one or more systems. For example, one or more data messages may be received from the scheduling system 110 (shown in FIG. 1), the travel system 112 (shown in FIG. 1), and/or the control system 114 (shown in FIG. 1). The data messages may include information such as scheduling information from the scheduling system 110, safety information from the travel system 112, and/or control information from the control system 114.

At 304, a format of the information included in the data message(s) is determined. For example, the format of the scheduling information, the safety information, the control information, and/or other information received from one or more of the systems 110, 112, 114 (shown in FIG. 1) may be identified.

At 306, a determination is made as to whether the format of the information in the received data message is compatible with a recipient of the data message. For example, the data message may be addressed to one or more rail vehicles and/or the systems 110, 112, 114 (shown in FIG. 1). A determination may be made as to which format or formats of data messages are able to be received and understood by the rail vehicle and/or system 110, 112, 114 to which the data message is addressed. The format of the data message may be compared with the compatible formats of the addressed rail vehicle and/or system 110, 112, 114. If the format of the data message (or the information included therein) is compatible with the addressed recipient of the data message, then flow of the method 300 can proceed to 310. Alternatively, if the format is incompatible with the addressed recipient, then the format of the data message or information may need to be changed before sending the data message or information to the addressed recipient. As a result, flow of the method 300 may proceed to 308.

At 308, a format of the data message and/or information included in the data message is changed. As described above, the format of the data message and/or information may be changed to a format that is compatible with the addressed recipient of the data message, as described above.

At 310, a determination is made as to whether the timing at which the data messages and/or information included in the data messages is conveyed to the addressed recipients of the data messages needs to be changed. For example, the timing at which information is transmitted from two or more systems 110, 112, 114 may be controlled so that a receiving system 110, 112, 114 receives the information in an order that can be used or is expected by the receiving system. The timing at which the data messages and/or information is to be transmitted to the rail vehicles and/or systems 110, 112, 114 may be different than the timing (e.g., order) in which the data messages and/or information are received by the communication unit 118 (shown in FIG. 1). If the timing of the data messages that are received at the communication unit 118 differs from the timing at which the data messages are to be sent to the rail vehicles and/or systems 110, 112, 114, then the timing (e.g., order) of the data messages may need to be changed. As a result, flow of the method 300 may proceed to 312. Alternatively, if the timing does not need to be changed, then flow of the method 300 may proceed to 314.

At 312, the timing of the data messages and/or information is changed. For example, the order in which the information is included in the data messages and/or the order in which the data messages are conveyed to the rail vehicles and/or systems 110, 112, 114 may be changed to an order that is expected by or associated with the rail vehicles and/or systems 110, 112, 114, as described above.

At 314, the data messages and/or information are sent to the addressed recipients. For example, the information that is included in one or more data messages received by the communication unit 118 may be reformatted (or the format may remain the same) and/or the order in which the data messages (and/or information included therein) are conveyed may be changed (or the order may remain the same). The information and/or data messages are then conveyed to the addressed recipients, such as the rail vehicles and/or the systems 110, 112, 114.

In another embodiment, a system (e.g., a system for controlling movement of vehicles) is provided that includes a communication unit configured to communicate with a scheduling system that determines schedules for plural vehicles to travel in a transportation network and with a control system that forms a trip plan for a first vehicle of the plural vehicles comprising operational settings for controlling movement of the first vehicle during a trip in the transportation network. The communication unit is configured to convey information between the scheduling system and the control system such that the scheduling system coordinates the schedules of the vehicles to maintain a throughput parameter of the transportation network and the control system forms the trip plan that reduces at least one of an amount of fuel consumed or an amount of emissions generated by the first vehicle during the trip according to the schedule associated with the first vehicle.

In another aspect, the communication unit is configured to communicate with the scheduling system that is disposed off-board the vehicles traveling in the transportation network.

In another aspect, the communication unit is configured to communicate with the control system that is disposed on-board the one or more of the vehicles.

In another aspect, the communication unit is configured to be disposed off-board the vehicles and to communicate with the control system disposed on-board the one or more of the vehicles.

In another aspect, the communication unit is configured to be disposed on-board the one or more of the vehicles and to communicate with the scheduling system.

In another aspect, the communication unit is configured to communicate at least one of destination locations or associated times of arrival at the destination locations to the vehicles such that the control system of the one or more of the vehicles can form the trip plan based on the at least one of the destination locations or the times of arrival.

In another aspect, the communication unit is configured to receive a geographic location from the one or more of the vehicles and to communicate the geographic location to the scheduling system such that the scheduling system forms the schedules for one or more other vehicles based on the geographic location.

In another aspect, the communication unit is configured to receive priority indices associated with the vehicles and to communicate the priority indices to the scheduling system such that the scheduling system forms one or more of the schedules so that the vehicles having greater priority indices arrive at associated destination locations in the transportation network before the vehicles having lower priority indices.

In another aspect, the communication unit includes an identification module and a conversion module. The identification module is configured to determine a first format of a first data message that includes the information received from at least one of the scheduling system or the control system. The conversion module is configured to change the first format of the first data message to a different, second format to form a second data message. The communication unit transmits the second data message to the other of the scheduling system or the control system.

In another aspect, the first format is a closed format and the second format is an open format.

In another aspect, the first format is a first closed format and the second format is a second closed format.

In another embodiment, a method (e.g., a method for controlling movement of vehicles) is provided that includes receiving information from at least one of a scheduling system and a control system. The scheduling system determines schedules for plural vehicles traveling along interconnected routes of a transportation network. The control system forms a trip plan for controlling at least one of tractive efforts or braking efforts of a first vehicle of the plural vehicles during a trip of the first vehicle in the transportation network. The method also includes conveying the information to the other of the scheduling system or the control system such that the scheduling system coordinates the schedules of the vehicles to maintain a throughput parameter of the transportation network or the control system forms the trip plan that is used by the first vehicle to reduce an amount of fuel consumed during the trip of the first vehicle according to the schedule associated with the first vehicle.

In another aspect, at least one of receiving the information or conveying the information includes receiving the information from the scheduling system disposed off-board the vehicles or conveying the information to the scheduling system disposed off-board the vehicles.

In another aspect, at least one of receiving the information or conveying the information includes receiving the information from the control system that is disposed on-board the one or more of the vehicles or conveying the information to the control system disposed on-board the one or more of the vehicles.

In another aspect, receiving the information and conveying the information is performed off-board of the vehicles.

In another aspect, receiving the information and conveying the information is performed on-board at least one of the vehicles.

In another aspect, conveying the information includes communicating at least one of destination locations or associated times of arrival at the destination locations to the vehicles such that the control system of the one or more of the vehicles can form the trip plan based on the at least one of the destination locations or the times of arrival.

In another aspect, receiving the information includes receiving a geographic location from the one or more of the vehicles and conveying the information includes communicating the geographic location to the scheduling system such that the scheduling system forms the schedules for one or more other vehicles based on the geographic location.

In another aspect, receiving the information includes receiving priority indices associated with the vehicles and conveying the information includes communicating the priority indices to the scheduling system such that the scheduling system forms one or more of the schedules so that the vehicles having greater priority indices arrive at associated destination locations in the transportation network before the vehicles having lower priority indices.

In another aspect, the method also includes determining a first format of a first data message that includes the information that is received and converting the first format of the first data message to a different, second format to form a second data message. Conveying the information can include communicating the second data message to the other of the scheduling system or the control system.

In another aspect, the first format is a closed format and the second format is an open format.

In another aspect, the first format is a first closed format and the second format is a second closed format.

In another embodiment, a computer readable storage medium for a system having a processor is provided. The computer readable storage medium includes one or more sets of instructions that direct the processor to receive information from at least one of a scheduling system and a control system. The scheduling system determines schedules for plural vehicles traveling along interconnected routes of a transportation network. The control system forms a trip plan for controlling at least one of tractive efforts or braking efforts of one or more of the vehicles during a trip of the one or more of the vehicles in the transportation network. The one or more sets of instructions also direct the processor to convey the information to the other of the scheduling system or the control system such that the scheduling system coordinates the schedules of the vehicles to maintain a throughput parameter of the transportation network or the control system forms the trip plan that is used by the one or more of the vehicles to reduce an amount of fuel consumed during the trip of the one or more of the vehicles according to at least one of the schedules associated with the one or more vehicles.

In another aspect, the one or more sets of instructions direct the processor to at least one of receive the information from the scheduling system disposed off-board the vehicles or convey the information to the scheduling system disposed off-board the vehicles.

In another aspect, the one or more sets of instructions direct the processor to at least one of receive the information from the control system that is disposed on-board the one or more of the vehicles or convey the information to the control system disposed on-board the one or more of the vehicles.

In another aspect, the one or more sets of instructions direct the processor to communicate at least one of destination locations or associated times of arrival at the destination locations to the vehicles such that the control system of the one or more of the vehicles can form the trip plan based on the at least one of the destination locations or the times of arrival.

In another aspect, the one or more sets of instructions direct the processor to receive a geographic location from the one or more of the vehicles and to communicate the geographic location to the scheduling system such that the scheduling system forms the schedules for one or more other vehicles based on the geographic location.

In another aspect, the one or more sets of instructions direct the processor to receive priority indices associated with the vehicles and to communicate the priority indices to the scheduling system such that the scheduling system forms one or more of the schedules so that the vehicles having greater priority indices arrive at associated destination locations in the transportation network before the vehicles having lower priority indices.

In another aspect, the one or more sets of instructions direct the processor to determine a first format of a first data message that includes the information that is received, convert the first format of the first data message to a different, second format to form a second data message, and communicate the second data message to the other of the scheduling system or the control system.

In another aspect, the first format is a closed format and the second format is an open format.

In another aspect, the first format is a first closed format and the second format is a second closed format.

In another embodiment, another system (e.g., a system for communicating with vehicles) includes a scheduling module, a communication module, and a monitoring module. The scheduling module is configured to determine scheduling information for plural vehicles that directs movement of the vehicles in a transportation network. The scheduling information includes plural locations and associated arrival times for each of the vehicles to travel to the locations. The communication module is configured to communicate the scheduling information to the vehicles. The monitoring module is configured to determine a bandwidth limitation of a communication link over which the scheduling information is communicated with one or more of the vehicles. The scheduling module is configured to direct the communication module to reduce an amount of the scheduling information that is communicated to the vehicles when the bandwidth limitation falls below a designated threshold by decreasing a number of the locations and the associated arrival times that are communicated to the vehicles.

In another aspect, the scheduling module is configured to direct the communication module to communicate only a next location of the locations and the associated arrival time of the next location to each of the vehicles when the bandwidth limitation falls below the designated threshold.

In another aspect, the scheduling information includes a designated trip plan that dictates at least one of speeds, throttle settings, or brake settings for the vehicles to travel according to as a function of one or more of distance or time during a trip in the transportation network. The trip plan is configured to cause at least one of the vehicles to at least one of consume less fuel or generate fewer emissions relative to traveling in the transportation network according to another plan.

In another aspect, the scheduling module is configured to direct the communication module to communicate only a next portion of the trip plan to one or more of the vehicles when the bandwidth limitation falls below the designated threshold. The next portion of the trip plan includes a subset of the trip plan that follows a current location of the one or more of the vehicles.

In another aspect, the scheduling module is configured to direct the communication module to communicate a plan identifier associated with a stored trip plan that is locally stored on a memory of one or more of the vehicles so that the one or more vehicles can obtain the stored trip plan for use in traveling in the transportation network.

In another aspect, the scheduling module is configured to direct the communication module to broadcast the plan identifier to each of a plurality of the vehicles so that each of the plurality of the vehicles travels according to the trip plan.

In another aspect, the scheduling module is configured to select the plan identifier to broadcast to the plurality of the vehicles based on a comparison of operating characteristics of the plurality of the vehicles.

In another aspect, one or more of the operating characteristics includes a mechanical limitation of at least one of the vehicles and the scheduling module is configured to select the plan identifier to broadcast to the plurality of vehicles so that at least one of the vehicles having a diminished mechanical limitation relative to other vehicles can travel according to the stored trip plan that is associated with the plan identifier.

In another aspect, the scheduling module is configured to receive an identification of which of a set of trip plans can be followed by one or more of the vehicles and, based on the identification, broadcast at least one of the trip plans in the set to the vehicles for the vehicles to travel according to in the transportation network.

In another embodiment, another method (e.g., a method for communicating with vehicles) includes determining scheduling information for plural vehicles that directs movement of the vehicles in a transportation network. The scheduling information includes plural locations and associated arrival times for each of the vehicles to travel to the locations. The method also includes communicating the scheduling information to the vehicles and monitoring a bandwidth limitation of a communication link over which the scheduling information is communicated with one or more of the vehicles. An amount of the scheduling information that is communicated to the vehicles is reduced when the bandwidth limitation falls below a designated threshold by decreasing a number of the locations and the associated arrival times that are communicated to the vehicles.

In another aspect, communicating the scheduling information includes communicating only a next location of the locations and the associated arrival time of the next location to each of the vehicles when the bandwidth limitation falls below the designated threshold.

In another aspect, the scheduling information includes a designated trip plan that dictates at least one of speeds, throttle settings, or brake settings for the vehicles to travel according to as a function of one or more of distance or time during a trip in the transportation network. The trip plan is configured to cause at least one of the vehicles to at least one of consume less fuel or generate fewer emissions relative to traveling in the transportation network according to another plan.

In another aspect, communicating the scheduling information includes communicating only a next portion of the trip plan to one or more of the vehicles when the bandwidth limitation falls below the designated threshold. The next portion of the trip plan includes a subset of the trip plan that follows a current location of the one or more of the vehicles.

In another aspect, communicating the scheduling information includes communicating a plan identifier associated with a stored trip plan that is locally stored on a memory of one or more of the vehicles so that the one or more vehicles can obtain the stored trip plan for use in traveling in the transportation network.

In another aspect, communicating the scheduling information includes broadcasting the plan identifier to each of a plurality of the vehicles so that each of the plurality of the vehicles travels according to the trip plan.

In another aspect, the method also includes comparing operating characteristics of the plurality of the vehicles and selecting the plan identifier to broadcast to the plurality of the vehicles based on the operating characteristics that are compared.

In another aspect, one or more of the operating characteristics includes a mechanical limitation of at least one of the vehicles and selecting the plan identifier includes selecting the plan identifier so that at least one of the vehicles having a diminished mechanical limitation relative to other vehicles can travel according to the stored trip plan that is associated with the plan identifier.

In another aspect, the method also includes receiving an identification of which of a set of trip plans can be followed by one or more of the vehicles and communicating the scheduling information includes broadcasting at least one of the trip plans in the set to the vehicles for the vehicles to travel according to in the transportation network based on the identification.

Another embodiment relates to a method. The method comprises determining scheduling information for plural vehicles that directs movement of the vehicles in a transportation network. The scheduling information includes plural locations and associated arrival times for each of the vehicles to travel to the locations. The method further comprises communicating the scheduling information to the vehicles, and monitoring a bandwidth parameter of a communication link over which the scheduling information is communicated with one or more of the vehicles. The parameter is a monitored characteristic of the bandwidth of the communication link, that is, the parameter is a measure of some aspect of the bandwidth. When the bandwidth parameter meets one or more designated criteria, an amount of the scheduling information that is communicated to the vehicles is reduced. This is done by decreasing a number of the locations and the associated arrival times that are communicated to the vehicles.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the disclosed subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

This written description uses examples to disclose several embodiments of the inventive subject matter, including the best mode, and also to enable a person of ordinary skill in the art to practice the embodiments of inventive subject matter, including making and using any devices or systems and performing any incorporated methods. The patentable scope of the inventive subject matter is defined by the claims, and may include other examples that occur to a person of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described systems and methods, without departing from the spirit and scope of the inventive subject matter herein involved, it is intended that all of the subject matter of the above description or shown in the accompanying drawings shall be interpreted merely as examples illustrating the inventive concept herein and shall not be construed as limiting the inventive subject matter.

What is claimed is:

1. A system comprising:
a communication unit configured to communicate with a scheduling system that determines schedules for plural vehicles to travel in a transportation network and with a control system that forms a trip plan for a first vehicle of the plural vehicles, the trip plan comprising operational settings for controlling movement of the first vehicle during a trip in the transportation network;
wherein the communication unit is configured to convey information between the scheduling system and the control system such that the scheduling system coordinates the schedules of the vehicles to maintain a throughput parameter of the transportation network and the control system forms the trip plan that reduces at least one of an amount of fuel consumed or an amount of emissions generated by the first vehicle during the trip according to the schedule associated with the first vehicle.

2. The system of claim 1, wherein the communication unit is configured to communicate with the scheduling system that is disposed off-board the vehicles traveling in the transportation network.

3. The system of claim 1, wherein the communication unit is configured to communicate with the control system that is disposed on-board the one or more of the vehicles.

4. The system of claim 1, wherein the communication unit is configured to be disposed off-board the vehicles and to communicate with the control system disposed on-board the one or more of the vehicles.

5. The system of claim 1, wherein the communication unit is configured to be disposed on-board the one or more of the vehicles and to communicate with the scheduling system.

6. The system of claim 1, wherein the communication unit is configured to communicate at least one of destination locations or associated times of arrival at the destination locations to the vehicles such that the control system of the one or more of the vehicles can form the trip plan based on the at least one of the destination locations or the times of arrival.

7. The system of claim 1, wherein the communication unit is configured to receive a geographic location from the one or more of the vehicles and to communicate the geographic location to the scheduling system such that the scheduling system forms the schedules for one or more other vehicles based on the geographic location.

8. The system of claim 1, wherein the communication unit is configured to receive priority indices associated with the vehicles and to communicate the priority indices to the scheduling system such that the scheduling system forms one or more of the schedules so that the vehicles having greater priority indices arrive at associated destination locations in the transportation network before the vehicles having lower priority indices.

9. A method comprising:
receiving information from at least one of a scheduling system and a control system, the scheduling system determining schedules for plural vehicles traveling along interconnected routes of a transportation network, the control system forming a trip plan for controlling at least one of tractive efforts or braking efforts of a first vehicle of the plural vehicles during a trip of the first vehicle in the transportation network; and
conveying the information to the other of the scheduling system or the control system such that the scheduling system coordinates the schedules of the vehicles to maintain a throughput parameter of the transportation network or the control system forms the trip plan that is used by the first vehicle to reduce an amount of fuel consumed during the trip of the first vehicle according to the schedule associated with the first vehicle.

10. The method of claim 9, wherein at least one of receiving the information or conveying the information includes receiving the information from the scheduling system disposed off-board the vehicles or conveying the information to the scheduling system disposed off-board the vehicles.

11. The method of claim 9, wherein at least one of receiving the information or conveying the information includes receiving the information from the control system that is disposed on-board the one or more of the vehicles or conveying the information to the control system disposed on-board the one or more of the vehicles.

12. The method of claim 9, wherein receiving the information and conveying the information is performed off-board of the vehicles.

13. The method of claim 9, wherein receiving the information and conveying the information is performed on-board at least one of the vehicles.

14. The method of claim 9, wherein conveying the information includes communicating at least one of destination locations or associated times of arrival at the destination locations to the vehicles such that the control system of the one or more of the vehicles can form the trip plan based on the at least one of the destination locations or the times of arrival.

15. The method of claim 9, wherein receiving the information includes receiving a geographic location from the one or more of the vehicles and conveying the information includes communicating the geographic location to the scheduling system such that the scheduling system forms the schedules for one or more other vehicles based on the geographic location.

16. The method of claim 9, wherein receiving the information includes receiving priority indices associated with the vehicles and conveying the information includes communicating the priority indices to the scheduling system such that the scheduling system forms one or more of the schedules so that the vehicles having greater priority indices arrive at associated destination locations in the transportation network before the vehicles having lower priority indices.

17. The method of claim 9, further comprising:
determining a first format of a first data message that includes the information that is received; and
converting the first format of the first data message to a different, second format to form a second data message,
wherein conveying the information includes communicating the second data message to the other of the scheduling system or the control system.

18. A system comprising:
a scheduling module configured to determine scheduling information for plural vehicles that directs movement of the vehicles in a transportation network, the scheduling information including plural locations and associated arrival times for each of the vehicles to travel to the locations;
a communication module configured to communicate the scheduling information to the vehicles; and
a monitoring module configured to determine a bandwidth limitation of a communication link over which the scheduling information is communicated with one or more of the vehicles, wherein the scheduling module is configured to direct the communication module to reduce an amount of the scheduling information that is communicated to the vehicles when the bandwidth limitation falls below a designated threshold by decreasing a number of the locations and the associated arrival times that are communicated to the vehicles.

19. The system of claim 18, wherein the scheduling module is configured to direct the communication module to communicate only a next location of the locations and the associated arrival time of the next location to each of the vehicles when the bandwidth limitation falls below the designated threshold.

20. The system of claim 18, wherein the scheduling information includes a designated trip plan that dictates at least one of speeds, throttle settings, or brake settings for the vehicles to travel according to as a function of one or more of distance or time during a trip in the transportation network, and the trip plan is configured to cause at least one of the vehicles to at least one of consume less fuel or generate fewer emissions relative to traveling in the transportation network according to another plan.

21. The system of claim 20, wherein the scheduling module is configured to direct the communication module to communicate only a next portion of the trip plan to one or more of the vehicles when the bandwidth limitation falls below the designated threshold, the next portion of the trip plan including a subset of the trip plan that follows a current location of the one or more of the vehicles.

22. The system of claim 20, wherein the scheduling module is configured to direct the communication module to communicate a plan identifier associated with a stored trip plan that is locally stored on a memory of one or more of the vehicles so that the one or more vehicles can obtain the stored trip plan for use in traveling in the transportation network.

23. The system of claim 22, wherein the scheduling module is configured to direct the communication module to broadcast the plan identifier to each of a plurality of the vehicles so that each of the plurality of the vehicles travels according to the trip plan.

24. The system of claim 23, wherein the scheduling module is configured to select the plan identifier to broadcast to the plurality of the vehicles based on a comparison of operating characteristics of the plurality of the vehicles.

25. The system of claim 24, wherein one or more of the operating characteristics includes a mechanical limitation of at least one of the vehicles and the scheduling module is configured to select the plan identifier to broadcast to the plurality of vehicles so that at least one of the vehicles having a diminished mechanical limitation relative to other vehicles can travel according to the stored trip plan that is associated with the plan identifier.

26. The system of claim 20, wherein the scheduling module is configured to receive an identification of which of a set of trip plans can be followed by one or more of the vehicles and, based on the identification, broadcast at least one of the trip plans in the set to the vehicles for the vehicles to travel according to in the transportation network.

27. A method comprising:
determining scheduling information for plural vehicles that directs movement of the vehicles in a transportation network, the scheduling information including plural locations and associated arrival times for each of the vehicles to travel to the locations;
communicating the scheduling information to the vehicles; and
monitoring a bandwidth limitation of a communication link over which the scheduling information is communicated with one or more of the vehicles, wherein an amount of the scheduling information that is communicated to the vehicles is reduced when the bandwidth limitation falls below a designated threshold by decreasing a number of the locations and the associated arrival times that are communicated to the vehicles.

28. The method of claim 27, wherein communicating the scheduling information includes communicating only a next location of the locations and the associated arrival time of the next location to each of the vehicles when the bandwidth limitation falls below the designated threshold.

29. The method of claim 27, wherein the scheduling information includes a designated trip plan that dictates at least one of speeds, throttle settings, or brake settings for the vehicles to travel according to as a function of one or more of distance or time during a trip in the transportation network, and the trip plan is configured to cause at least one of the vehicles to at least one of consume less fuel or generate fewer emissions relative to traveling in the transportation network according to another plan.

30. The method of claim 29, wherein communicating the scheduling information includes communicating only a next portion of the trip plan to one or more of the vehicles when the bandwidth limitation falls below the designated threshold, the next portion of the trip plan including a subset of the trip plan that follows a current location of the one or more of the vehicles.

31. The method of claim 29, wherein communicating the scheduling information includes communicating a plan identifier associated with a stored trip plan that is locally stored on a memory of one or more of the vehicles so that the one or more vehicles can obtain the stored trip plan for use in traveling in the transportation network.

32. The method of claim 31, wherein communicating the scheduling information includes broadcasting the plan identifier to each of a plurality of the vehicles so that each of the plurality of the vehicles travels according to the trip plan.

33. The method of claim 32, further comprising comparing operating characteristics of the plurality of the vehicles and selecting the plan identifier to broadcast to the plurality of the vehicles based on the operating characteristics that are compared.

34. The method of claim 33, wherein one or more of the operating characteristics includes a mechanical limitation of at least one of the vehicles and selecting the plan identifier includes selecting the plan identifier so that at least one of the vehicles having a diminished mechanical limitation relative to other vehicles can travel according to the stored trip plan that is associated with the plan identifier.

35. The method of claim 29, further comprising receiving an identification of which of a set of trip plans can be followed by one or more of the vehicles and communicating the scheduling information includes broadcasting at least one of the trip plans in the set to the vehicles for the vehicles to travel according to in the transportation network based on the identification.
